(19) United States
(12) Patent Application Publication
(10) Pub. No.: US 2008/0226173 A1
(43) Pub. Date: Sep. 18, 2008

(54) METHOD AND APPARATUS FOR VIDEO CLIP SEARCHING AND MINING

(75) Inventors: Junsong Yuan, Evanston, IL (US); Wei Wang, Barrington, IL (US); Zhu Li, Palatine, IL (US); Dongge Li, Hoffman Estates, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/685,720

(22) Filed: Mar. 13, 2007

(51) Int. Cl. G06K 9/46

(52) U.S. Cl. 382/190

(57) ABSTRACT

A method, apparatus, and electronic device for searching for repetitive video content are disclosed. A memory may store a set of video data. A processor may match a premier query window to a trellis match video window of the set of video data. The processor may compare a successive query window to a successive trellis match video window. The processor may disregard the trellis match video window if the successive trellis match video window does not match the successive query window.

### FIELD OF THE INVENTION

The present invention relates to a method and system for video searching, video mining, content association, and clustering. The present invention further relates to automatically detecting repeated video clips.

### INTRODUCTION

Modern mobile telecommunications devices, such as cellular telephones, may download a variety of media content. This media content may include such media types as video. The video content may be any of a variety of formats, such as standards provided by Moving Picture Experts Group (MPEG) (Including MPEG 1, Layer 3 (MP3)), and others.

The video content may be made of a set of individual frames, showing images without any temporal component. These frames may be grouped into video clips, showing a series of frames over a specified temporal period. Often a video sequence of a set of video data content may include a number of repeated video clips. These video clips may be intentionally included by the video content provider, or may be due to errors that may occur during the transmission of the data. A user may want to have the extra clips removed prior to viewing the video data content. Sorting out the repetitive video clips currently requires a substantial amount of processing power.

The major difficulty of repetitive clip discovery is that, barring personally watching the video, the user may not know where the repetitive clips are and how long they are. One method includes checking every different length of video clips for every frame of video data. This naïve mining method is computationally expensive. For example, suppose the database is of size n, the total number of possible segments needed to query in the database is:

$${\sum }_{k = 1}^{n} ( n - k + 1 ) \times k = \frac{{n}^{3} + 3 {n}^{2} + 2 n}{6}$$

For each query, the database must search to find its best matched candidates. Therefore the computational cost can be of a complexity O(n⁴) by using the naive mining method. This is not a reasonable solution for large database.

### SUMMARY OF THE INVENTION

A method, mobile telecommunications apparatus, and electronic device for searching for repetitive video content are disclosed. A memory may store a set of video data. A processor may match a premier query window to a trellis match video window of the set of video data. The processor may compare a successive query window to a successive trellis match video window. The processor may disregard the trellis match video window if the successive trellis match video window does not match the successive query window.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1a-b illustrate in block diagrams two types of video searches.

FIG. 2 illustrates in a flowchart one embodiment of a method for producing a signature for comparing video clips.

FIG. 3 illustrates in a flowchart a method for creating an ordinal feature signature.

FIGS. 4a-b illustrate in block diagrams the creation of an ordinal feature signature.

FIG. 5 illustrates in a flowchart one embodiment of a method for creating a cumulative color histogram.

FIG. 6 illustrates in a flowchart one embodiment of a method executing a naïve video clip search.

FIG. 7 illustrates in a flowchart one embodiment of a method of a nearest neighbor trellis based pruning solution.

FIG. 8 illustrates in a block diagram a nearest neighbor trellis.

FIG. 9 illustrates a possible configuration of a computer system to act as a mobile system or location server to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for searching for repetitive video content are disclosed. A memory may store a set of video data. A processor may match a premier query window to a trellis match video window of the set of video data. The processor may compare a successive query window to a successive trellis match video window. The processor may disregard the trellis match video window if the successive trellis match video window does not match the successive query window.

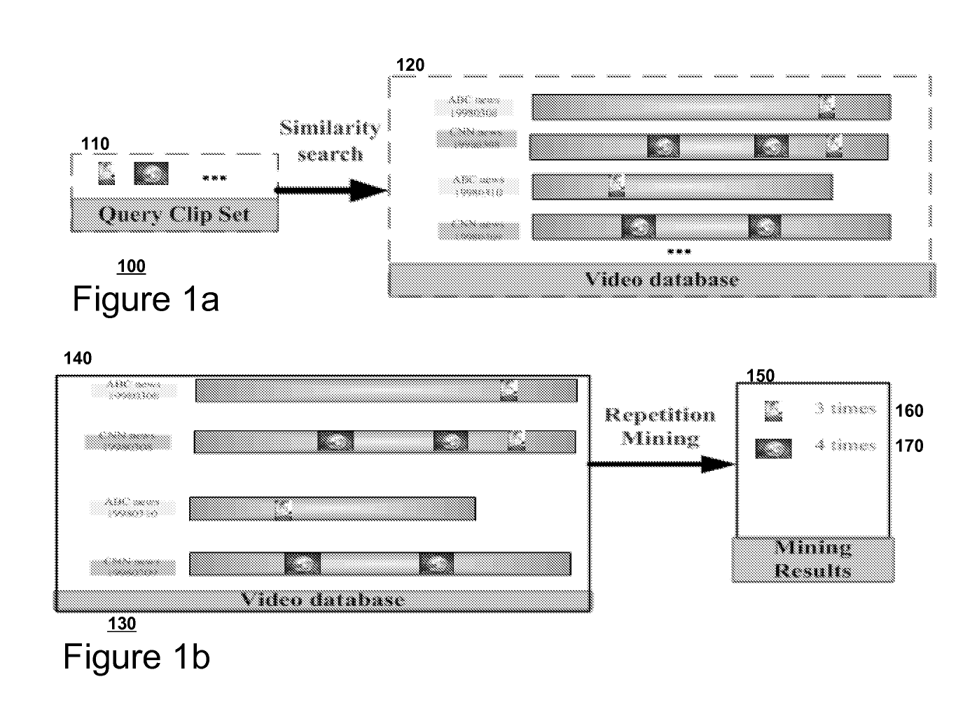

FIGS. 1a-b illustrate in block diagrams two types of video searches. FIG. 1a illustrates one embodiment of a query clip search 100. In a query clip search 100, a query clip set 110 is matched to video clips that are part of one or more video sequences in a video database 120. FIG. 1b illustrates one embodiment of a repetitive clip search 130. One or more video sequences in a video database 140 may be searched for any clips that repeat elsewhere in the video sequences, noting any clips 150 that repeat. In this example, a first video clip 160 is found to repeat three times, and a second video clip 170 is found to repeat four times.

For the tasks of video clip search and repetition discovery, feature, or signature, extraction may produce compact, robust and distinguishable signatures. Ordinal feature and color feature may be combined to serve as the signatures. Segmenting long video sequences into fixed length windows and comparing the video feature signatures may classify the video content of the video database. Compared with key frame based shot representation, the ambiguity of key frame selection and the difficulty of detecting gradual shot transition are thus avoided. Note such gradual shot transitions appear very commonly in commercials and program lead-in and lead-out due to post editing.

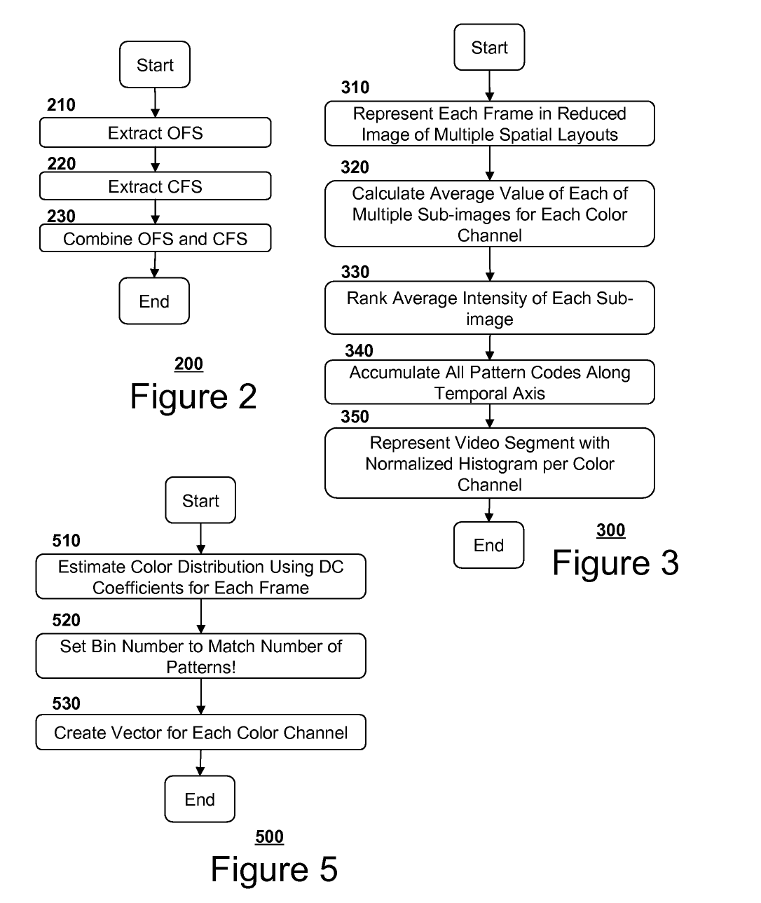

FIG. 2 illustrates in a flowchart one embodiment of a method 200 for producing a signature for comparing video clips. For a given segment of video data, a video processor may extract an ordinal feature signature (OFS) (Block 210). An OFS categorizes the spatial and temporal features of a video segment. The video processor may extract a color feature signature (CFS) (Block 220). The CFS may categorize the color range information of a video segment. The video processor may combine the OFS and the CFS to create a video feature signature, that may be used to determine if two video segments match (Block 230).

Using video feature figure signatures to characterize video segments has many advantages. An ordinal pattern distribution histogram provides a unique sparse distribution, and thus is more distinguishable than a CFS alone. The OFS is a good supplement to a CFS as it provides spatial-temporal information. Thus when combined with the color histograms, such signatures can lead towards a robust feature set. Ordinal pattern distribution is insensitive to a global color shifting, color format changes or other coding variations such as frame size change, rate change, and others.

FIG. 3 illustrates in a flowchart one embodiment of a method 300 for creating an OFS. The video processor may represent each frame of a video segment in a reduce image (Block 310). The reduced image may have multiple spatial layouts.

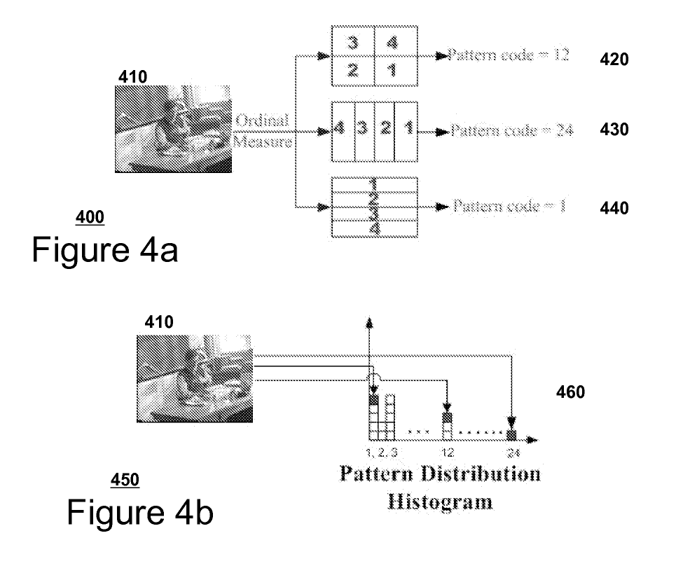

FIG. 4a illustrates in a block diagram reducing 400 the image into different spatial layouts. The image 410 may be divided into multiple sub-images. In the present example, the image 410 is divided into four sub-images. The layouts may arrange the sub-images into three spatial layouts, a 2×2 pattern 420, a 4×1 pattern 430, or a 1×4 pattern 440. By measuring different spatial layouts of the images, the signature becomes more distinguishable.

Returning to FIG. 3, the video processor may calculate the average value for each color channel of each of the multiple sub-images used to make up the multiple spatial layouts (Block 320). The color channels may include luminescence (Y), red content (Cr), and blue content (Cb). The video processor may follow the raw feature extraction with the ordinal measure process, ranking the average intensity values of each sub-image (Block 330). Each possible combination of ordinal measure results may be treated as an individual pattern code. Each frame may have a pattern code for each different spatial layout. To characterize a video segment, the video processor accumulates all the pattern codes along the temporal axis to form a histogram (Block 340). The video processor may represent a video segment with a normalized ordinal pattern distribution histogram for each of the color channels applied to the image (Block 350).

For example, a video segment can be compactly represented by 3 normalized 24-dimensional ordinal pattern distribution histograms, corresponding to Y, Cb, and Cr channels respectively. For each channel c=Y, Cb, Cr, the video clip is represented as:

$${H}_{c}^{opd} = ( {h}_{1} , {h}_{2} , … , {h}_{l} , … , {h}_{NoP} ) 0 \leq {h}_{i} \leq 1 and {\sum }_{i} {h}_{i} = 1 \qquad ( 1 )$$

Here the number of possible patterns (NoP=4!=24) is the dimension of the histogram. As a result, the total dimension of the spatial-temporal signature H^{opd} also becomes 72. FIG. 4b illustrates in graphic form 450 one such histogram 460 developed from an image 410.

The cumulative color histograms of all the frames within a video segment may be used as the color signature. FIG. 5 illustrates in a flowchart one embodiment of a method 500 for creating a cumulative color histogram. For computational simplicity, the video processor may estimate the cumulative color distribution using the DC coefficients extracted from a frame in a MPEG Moving Picture Experts Group (MPEG) standard compressed video stream (Block 510). The normalized cumulative histogram is:

$${H}^{ccd} = \frac{1}{M} {\sum }_{i = {b}_{k}}^{{b}_{k} + M - 1} {H}_{i} ( j ) j = 1 , … , B \qquad ( 3 )$$

where Hᵢ|i=bₖ, bₖ₊₁, . . . , b_{k+M-1} denotes the color histogram of the corresponding frame within the video sequence. M is the number of frames and B is the color bin number. The video processor may set the color bin number to equal the number of possible patterns (Block 520). In this example, B is selected as 24 for uniform quantization. The video processor may create a color feature vector for each color channel, such as Y, Cb and Cr (Block 530). H_{c}^{ccd} may thus be a 24-dimensional feature vector. The total size of the color signature H^{ccd} may be 72-dimension. Finally the video feature signature dimensionality becomes 144.

The video clip search problem may be formulated as an approximate nearest neighbor search problem. Where ε-Nearest Neighbor Search (ε-NNS) and given a set P of n points in a norm space l^{d}, P is preprocessed so as to efficiently return a point p in P for any given query point q, such that d(q,p)<=(1+ε)d(q, P), where d(p,P) is the distance of q to its closest point in P.

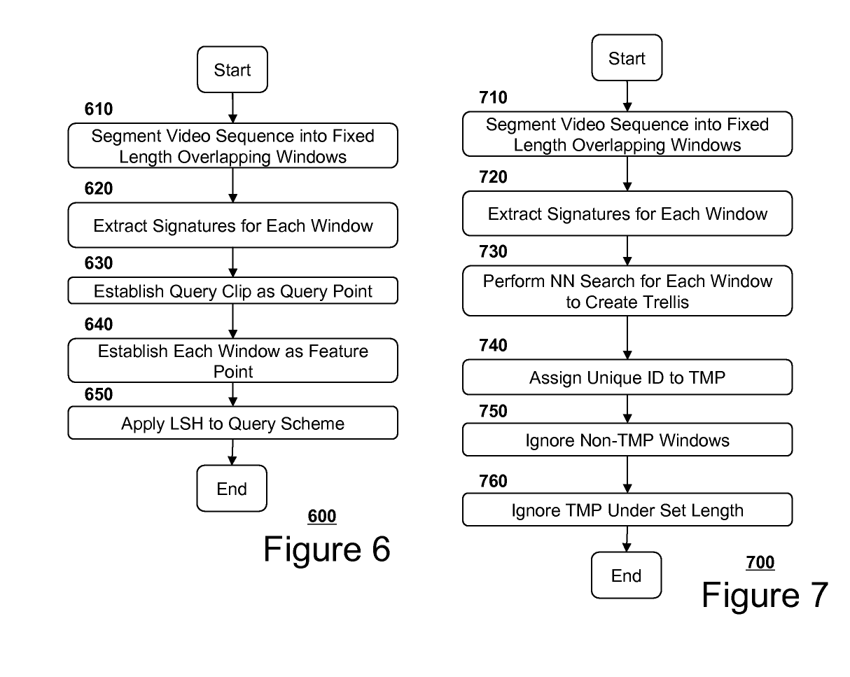

FIG. 6 illustrates in a flowchart one embodiment of a method 600 executing a naïve video clip search. The video processor may segment any long video sequences in the video database 120 into fixed length windows (Block 610). The length of these windows may be set to be the same as the length of the query. The windows in this series of windows may also overlap with each other, with an interval of, for example, 0.4 seconds. The video processor may extract video feature signatures from the windows (Block 620). The video processor may establish the query clip as the query point in the feature space (Block 630). The video processor may establish each video segment in the database as a feature point in the feature space (Block 640). The video processor may apply a locality sensitive hash (LSH) function as the fast query scheme (Block 650).

FIG. 7 illustrates in a flowchart one embodiment of a method 700 of a nearest neighbor (NN) trellis based pruning solution. The video processor may segment any long video sequences in the video database 120 into fixed length overlapping windows (Block 710). The video processor may extract video feature signatures from the windows (Block 720). The video processor may then perform a NN search for each of the windows to create a trellis (Block 740).

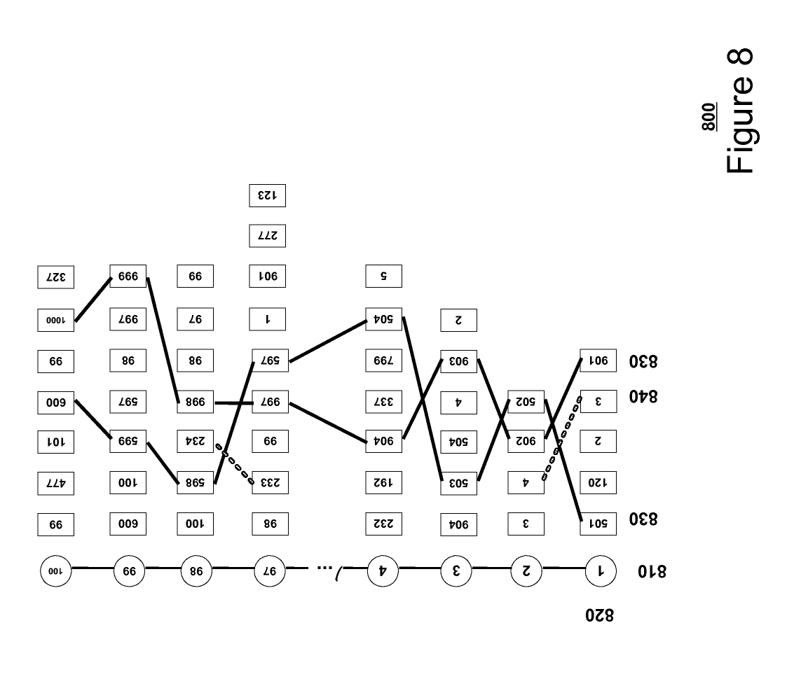

FIG. 8 illustrates in a block diagram a NN trellis 800. The top row 810 of nodes on the trellis represents original video sequence of the natural order formed by the image sequence of continuous temporal positions. The first window of the top row 810 may be established as the premier query window for purposes of searching to create the trellis. Each column 820 in the trellis is the ε-NN search results of the node in the top row. For example, the 1^{st} video window, or premier query video window, in the database may have a good similarity match with the 2^{nd}, 3^{rd}, 120^{th}, 501^{st}, and 901^{st} video windows. Some of these trellis match video windows, or video windows in the trellis that match the premier video window, have successive video windows that match successive video windows of the premier query video window. These trellis match paths 830 may be considered instances of the video clip formed in the top row, the target of repetitive clip mining. These found paths 830 are continuous in terms of the temporal position index, but are formed by the nearest neighbors of the nodes in the original line. For each continuous path, it will be attributed a unique ID when established. The path is valid only if it has enough length. For example, the short paths 840 are not valid as they are not long enough. They may be treated as random effects.

Returning to FIG. 7, the video processor may assign a unique path identifier to any trellis match paths (TMPs) 830 (Block 740). The video processor may ignore any windows that are not part of the TMP (Block 750). The video processor may ignore any TMPs that fail to meet a minimum number of windows (Block 760).

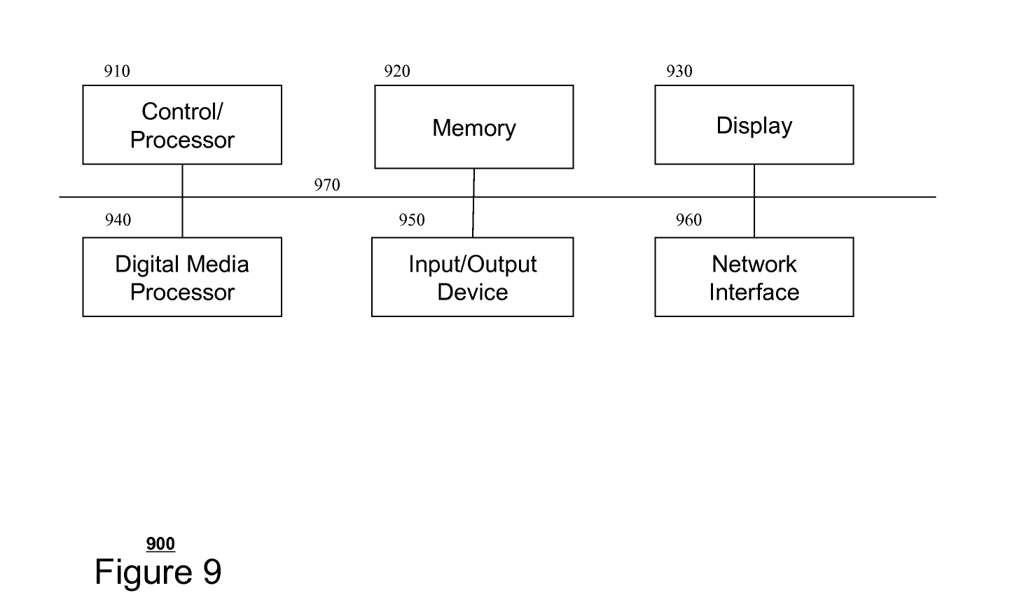

FIG. 9 illustrates a possible configuration of a computing system 900 to act as a mobile telecommunications apparatus or electronic device to execute the present invention. The computer system 900 may include a controller/processor 910, a memory 920, display 930, a digital media processor 940, input/output device interface 950, and a network interface 960, connected through bus 970. The computer system 900 may implement any operating system, such as Windows or UNIX, for example. Client and server software may be written in any programming language, such as ABAP, C, C++, Java or Visual Basic, for example.

The controller/processor 910 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 920 may include volatile and nonvolatile data storage, including one or more electrical, magnetic or optical memories such as a random access memory SAM), cache, hard drive, or other memory device. The memory may have a cache to speed access to specific data. The memory 920 may also be connected to a compact disc-read only memory (CD-ROM), digital video disc-read only memory (DVD-ROM), DVD read write input, tape drive or other removable memory device that allows media content to be directly uploaded into the system.

The digital media processor 940 is a separate processor that may be used by the system to more efficiently present digital media. Such digital media processors may include video cards, audio cards, or other separate processors that enhance the reproduction of digital media.

The Input/Output interface 950 may be connected to one or more input devices that may include a keyboard, mouse, pen-operated touch screen or monitor, voice-recognition device, or any other device that accepts input. The Input/Output interface 950 may also be connected to one or more output devices, such as a monitor, printer, disk drive, speakers, or any other device provided to output data.

The network interface 960 may be connected to a communication device, modem, network interface card, a transceiver, or any other device capable of transmitting and receiving signals over a network. The network interface 960 may be used to transmit the media content to the selected media presentation device. The network interface may also be used to download the media content from a media source, such as a website or other media sources. The components of the computer system 900 may be connected via an electrical bus 970, for example, or linked wirelessly.

Client software and databases may be accessed by the controller/processor 910 from memory 920, and may include, for example, database applications, word processing applications, the client side of a client/server application such as a billing system, as well as components that embody the decision support functionality of the present invention. The user access data may be stored in either a database accessible through the database interface 940 or in the memory 920. The computer system 900 may implement any operating system, such as Windows or UNIX, for example. Client and server software may be written in any programming language, such as ABAP, C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for searching video content, comprising:
matching a premier query window to a trellis match video window of a set of video data;
comparing a successive query window to a successive trellis match video window; and
disregarding the trellis match video window if the successive trellis match video window does not match the successive query window.

2. The method of claim 1, further comprising dividing the set of video data into a series of windows.

3. The method of claim 2, further comprising establishing a first window of the series of windows into the premier query window.

4. The method of claim 2, wherein a first window of the series of windows overlaps with a second window of the series of windows.

5. The method of claim 1, further comprising matching the premier video window to the trellis match video window by an ordinal feature signature and a color feature signature.

6. The method of claim 5, further comprising:
reducing a first sub-image and a second sub-image of the premier video window;
creating multiple spatial layouts from the first image and the second image; and
accumulating pattern codes of the multiple spatial layouts to form a histogram.

7. The method of claim 1, further comprising applying a locality sensitive hash to match the trellis match video window to the premier query window.

8. A mobile telecommunications apparatus that searches video content, comprising:
a memory that stores a set of video data; and
a processor that matches a premier query window to a trellis match video window of the set of video data, compares a successive query window to a successive trellis match video window, and disregards the trellis match video window if the successive trellis match video window does not match the successive query window.

9. The mobile telecommunications apparatus of claim 8, wherein the processor divides the set of video data into a series of windows.

10. The mobile telecommunications apparatus of claim 9, wherein the processor establishes a first window of the series of windows into the premier query window.

11. The mobile telecommunications apparatus of claim 9, wherein a first window of the series of windows overlaps with a second window of the series of windows.

12. The mobile telecommunications apparatus of claim 8, wherein the processor matches the premier video window to the trellis match video window by an ordinal feature signature and a color feature signature.

13. The mobile telecommunications apparatus of claim 12, wherein the processor reduces a first sub-image and a second sub-image of the premier video window, creates multiple spatial layouts from the first image and the second image, and accumulates pattern codes of the multiple spatial layouts to form a histogram.

14. The mobile telecommunications apparatus of claim 8, wherein the processor applies a locality sensitive hash to match the trellis match video window to the premier query window.

15. An electronic device that searches video content, comprising:
a memory that stores a set of video data; and
a processor that matches a premier query window to a trellis match video window of the set of video data, compares a successive query window to a successive trellis match video window, and disregards the trellis match video window if the successive trellis match video window does not match the successive query window.

16. The electronic device of claim 15, wherein the processor divides the set of video data into a series of windows.

17. The electronic device of claim 16, wherein the processor establishes a first window of the series of windows into the premier query window.

18. The electronic device of claim 15, wherein the processor matches the premier video window to the trellis match video window by an ordinal feature signature and a color feature signature.

19. The electronic device of claim 18, wherein the processor reduces a first sub-image and a second sub-image of the premier video window, creates multiple spatial layouts from the first image and the second image, and accumulates pattern codes of the multiple spatial layouts to form a histogram.

20. The electronic device of claim 15, wherein the processor applies a locality sensitive hash to match the trellis match video window to the premier query window.
